(19) United States
(12) Patent Application Publication
(10) Pub. No.: US 2014/0018194 A1
(43) Pub. Date: Jan. 16, 2014

(54) GOLF BALL METHOD OF MANUFACTURE AND GOLF BALL

(71) Applicant: Toshiro WACHI, Sekishi (JP)

(72) Inventor: Toshiro WACHI, Sekishi (JP)

(73) Assignee: BRIDGESTONE SPORTS CO., LTD., Tokyo (JP)

(21) Appl. No.: 13/547,692

(22) Filed: Jul. 12, 2012

(51) Int. Cl. B05D 5/00; B05D 3/12; B05D 3/06; A63B 37/12; B05D 3/02

(52) U.S. Cl. 473/378; 427/256; 427/535

(57) ABSTRACT

The invention provides a method of manufacturing golf balls which includes the step of printing specific markings on the surface of a golf ball by pad printing. Prior to the printing step, the surface of the ball is subjected to heat and pressure treatment.

### BACKGROUND OF THE INVENTION

The present invention relates to a method of manufacturing golf balls that uses pad printing, which is one technique for printing markings such as lettering and graphics.

Markings are displayed on the surface of a golf ball. The markings are composed of graphics, symbols and lettering which indicate, for example, the name of the manufacturer, a brand name representing the type of ball, and the ball number.

One printing technique that has hitherto been used to print markings such as lettering and graphics on the surface of a golf ball is pad printing. Pad printing uses a plate on which recessed areas in the shape of the markings to be printed on the ball surface have been formed. Ink in the recesses on the plate is caused to adhere to a pad composed of a material such as silicone rubber, and is then transferred by the pad to a target area on the ball surface. Because silicone rubber has a certain elasticity, it is soft and conforms even to a spherical surface possessing some degree of surface irregularity. Hence, pads made of silicone rubber are often used.

Art which employs pad printing as a means for printing markings on the surface of a golf ball is described in, for example, JP-A 10-114139 and JP-A 2009-195708.

Because golf balls are repeatedly used under harsh conditions, the markings printed on the ball surface are often damaged or stripped away. To address this problem, JP-A 2003-024475 discloses a technique that improves the adherence of markings to the surface of a golf ball by plasma treating only a predetermined region of the ball surface, then printing the markings thereon.

An approach that differs from the above surface treatment is described in JP-A 2004-243033, which teaches a technique that involves first pad printing markings onto a golf ball surface, then pad printing a clear protective layer onto the region of the ball surface with the markings. The purpose of providing a clear protective layer on the region with the pad-printed markings is to reduce damage to the markings and enhance the durability of the markings.

However, when the surface of a golf ball following cover formation by injection molding or the like is pretreated by being subjected to plasma treatment prior to the placement of markings on the ball surface, cover material grinding debris generated during such plasma treatment remains on the ball surface. During the pad printing of markings onto the ball surface, such grinding debris adheres to the pad, contaminating the printing plate which contains a recessed version of the markings, in addition to which the markings blur during printing and, in the worst case, may even scratch the printing plate, leading to the mass production of balls with defective markings.

Another technical document, JP-A 2002-337450, describes a printing process that involves hot stamping using a heated printing head.

### SUMMARY OF THE INVENTION

It is therefore an object of the invention to provide a golf ball manufacturing method which reliably removes cover grinding debris from the ball surface and is thus capable of mass producing balls on which markings have been well-printed, and which does not scratch the printing plate used in pad printing and thus extends the useful life of the plate, enabling the industrially advantageous manufacture of golf balls. Another object of the invention is to provide golf balls manufactured by such a method.

As a result of extensive investigations aimed at resolving the above problems, the inventor has discovered that when pad printing is employed as the means for printing desired markings onto the surface of a golf ball, by subjecting the surface of the ball prior to pad printing to a heat and pressure treatment step under given conditions, substantially no cover grinding debris remaining on the ball surface adheres to the pad used in pad printing, making it possible to reliably prevent contamination of the printing plate by grinding debris and, in turn, enabling balls on which the markings have been properly printed to be mass produced.

Accordingly, the invention provides the following golf ball manufacturing method and golf ball.

[1] A method of manufacturing golf balls, comprising the step of printing a specific marking on a surface of a golf ball by pad printing, wherein the printing step is preceded by the step of subjecting the ball surface to heat and pressure treatment.
[2] The golf ball manufacturing method of [1], wherein the heat and pressure treatment is carried out by using a sheet heated in a given manner, the sheet being pressed to the surface of the ball.
[3] The golf ball manufacturing method of [2], wherein silicone rubber is used as the sheet.
[4] The golf ball manufacturing method of [1] wherein, prior to carrying out heat and pressure treatment, the ball surface is pretreated by plasma treatment or corona discharge treatment.
[5] The golf ball manufacturing method of [1], wherein the heat and pressure treatment conditions comprise heating in the range of 100° C. to 200° C.
[6] The golf ball manufacturing method of [1], wherein, at the time of heat and pressure treatment, the ball has a deflection of from 0.2 mm to 5.0 mm.
[7] The golf ball manufacturing method of [1], wherein pressure is applied during heat and pressure treatment for a period of from 0.1 second to 3.0 seconds.
[8] A golf ball manufactured by the above manufacturing method.

### BRIEF DESCRIPTION OF THE DIAGRAMS

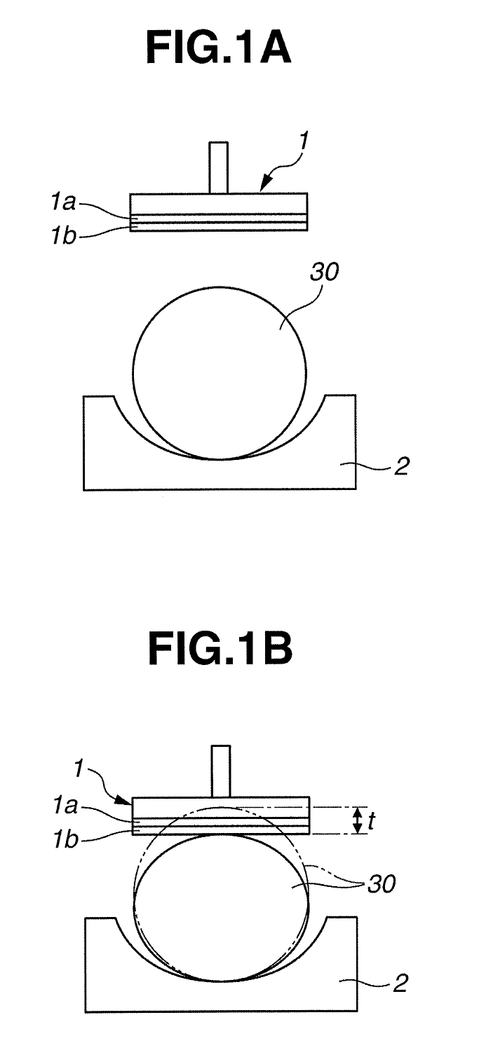

FIG. 1 is a schematic view illustrating the heat and pressure treatment step of the invention.

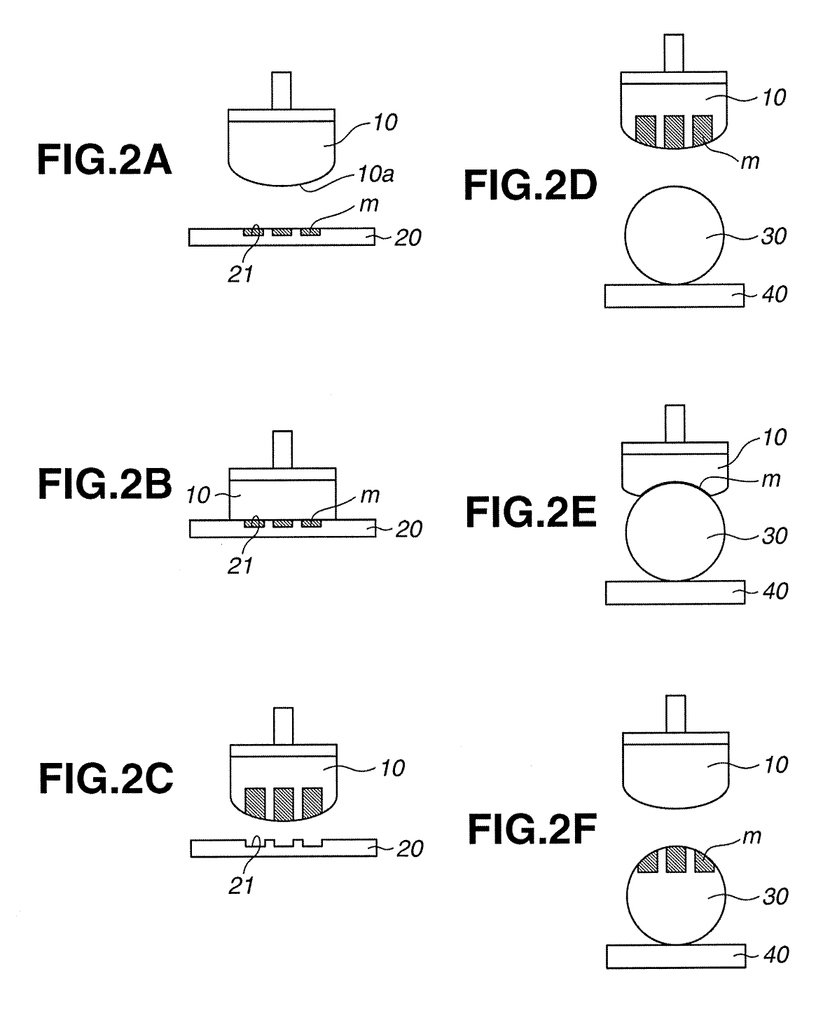

FIG. 2 is a schematic diagram depicting the pad printing process used in the invention.

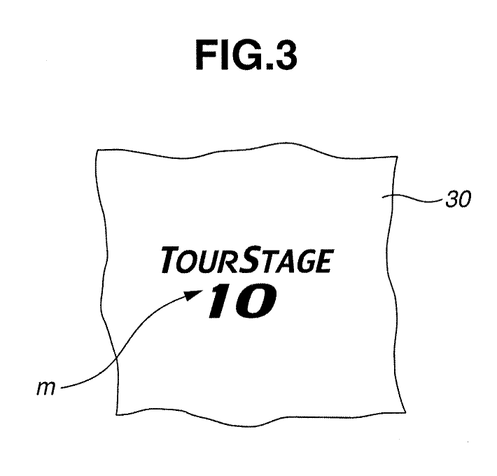

FIG. 3 is a simplified diagram showing the markings printed onto the surfaces of the golf balls used in the examples.

### DETAILED DESCRIPTION OF THE INVENTION

The invention is described more fully below.

The golf ball manufacturing method of the invention includes the step of printing specific markings on the surface of a golf ball by pad printing.

This invention is characterized in that the pad printing step is preceded by a heat and pressure treatment step. The heat and pressure treatment is carried out at a site on the ball surface where the marking is to be printed in the subsequent step, and entails pressing a sheet that has been heated in a given manner against the ball surface. By applying such heat and pressure treatment, cover material grinding debris adhering to the ball surface can be reliably removed, enabling the desired objects and effects of the invention to be achieved.

For example, as shown in FIG. 1, when heat and pressure treatment is carried out at a marking site on the surface of a golf ball, a sheet 1b of a certain elasticity that has been attached to a metal plate 1a of a hot pressing member 1 is pressed against a marking site on a ball surface 30 and heat from the metal plate 1a is transferred to the marking site on the ball surface 30 and the vicinity thereof, thereby removing cover material grinding debris adhering to the ball surface and evening out the fine irregularities created on the ball surface by roughening due to pretreatment and the like. FIG. 1 also shows a holder 2 for holding the ball.

No particular limitation is imposed on the conditions for heat and pressure treatment, although the heating temperature of the hot pressing member 1 composed of the metal plate 1a and the sheet 1b is typically in the range of from 100° C. to 200° C., and preferably from 130° C. to 200° C. At a heating temperature below this range, it may not be possible to fully remove the grinding debris. No particular limitation is imposed on the material making up the sheet 1b used on the hot pressing member 1, although use may be made of a resin endowed with both flexibility and followability, such as silicone rubber or urethane rubber.

The hot pressing member 1 is pressed against the ball surface 30 at a pressure of preferably from 0.1 MPa to 2.0 MPa, and more preferably from 0.3 MPa to 0.8 MPa. The pressing time, although not particularly limited, is preferably from 0.1 second to 3.0 seconds, and more preferably from 0.5 second to 1.5 seconds. At a heating time shorter than the above range, it may not be possible to completely remove the grinding debris. Although not shown in the diagram, the hot pressing member 1 is connected to an electrical heater, in addition to which advance, pressing and retreat of the hot pressing member 1 with respect to the surface of the golf ball can be controlled by using an air cylinder means coupled to a pressing controller.

At the time of hot pressing treatment, the ball deflects when pressed against by the sheet b of the hot pressing member 1. To achieve the objects and effects of the invention, it is desirable for the amount of deflection at this time, represented by the deflection t in FIG. 1, to be from 0.2 mm to 5.0 mm. If this deflection t is smaller than the above range, it may be difficult for heat from the sheet 1b of the hot pressing member 1 to fully transfer to the ball surface 30. On the other hand, if the above deflection t is too large, ball deformation becomes large and may leave behind signs of deformation, possibly lowering the performance of the ball.

Before applying the above heat and pressure treatment, the ball surface is subjected to preferably at least one type of pretreatment selected from among plasma treatment, corona discharge treatment, ultraviolet light irradiation treatment, chlorine treatment, primer coating, silane coupling agent coating treatment, and honing. The purpose of such pretreatment is to further increase adhesion between the applied coat and the ball surface when the surface of the golf ball is coated in a subsequent step.

When pretreatment such as plasma treatment is carried out on the ball surface as described above, the ball surface as seen microscopically acquires a roughened state, which helps improve adhesion of the markings later applied. On the other hand, the cover grinding debris attached to the ball surface disperses, and the removal of such cover grinding debris adhering to a ball surface having dimples becomes even more difficult. Hence, in the present invention, following the completion of such pretreatment, by applying a specific heat and pressure treatment, the cover grinding debris attached to the ball surface that was roughened in pretreatment is melted, enabling grinding debris on the ball surface to be eliminated. That is, the ball surface can be rendered smooth, thereby removing cover grinding debris composed of resin, along with which the fine irregularities on the ball surface that arose due to roughening by pretreatment or the like are evened out, making it possible to cleanly form markings on the ball surface during pad printing in a subsequent step. In particular, when pad printing is used in the marking printing step, if grinding debris on the ball surface adheres to the pad following transfer, this contaminates the printing plate containing a recessed version of the markings, giving rise to blurring of the printed area. In the worst case, the grinding debris scratches the printing plate, resulting in the mass production of balls with defective markings. Such undesirable effects can be resolved at the same time.

Techniques for printing markings include tape thermal transfer, pad printing and laser printing. In the present invention, pad printing is used. No particular limitation is imposed on the types, printing positions, and number of markings to be printed. Markings such as lettering, numbers, trade names and logos may be applied at any printing position.

In the invention, the thickness of the markings printed in the subsequent step is not particularly limited, although the thickness when transfer or the like has been carried out to the ball may be set to preferably from 2 μm to 16 μm, and especially from 3 μm to 6 μm.

Various known techniques of pad printing may be used without particular limitation. For example, markings may be printed onto the ball surface via the steps shown in FIGS. 2A to 2F. First, a pad 10 having a printing side 10a and an engraved printing plate 20 with recessed areas 21 that have been flooded with ink m are furnished for use (FIG. 2A). The ink m on the engraved plate 20 is allowed to soak into the printing side 10a of the pad 10 (FIGS. 2B, 2C). Next, the pad 10 is moved directly over the surface 30 of a golf ball that has been placed on a ball jig 40 (FIG. 2D) and the pad 10 is pushed against a marking site on the ball surface 30 (FIG. 2E), following which the pad 10 is raised up off the ball. The ink m can be transferred by means of these steps to the marking site on the ball surface 30, thus carrying out the operation of printing markings on the ball surface.

Clear coating (coating with a clear paint) may be applied to the golf ball on which such marking has been completed in order to protect the ball surface which includes the position of the markings and to improve the appearance. This clear coating is typically carried out by perching the ball on the needle tips of a needle bed and spraying so as to coat the entire ball. The paint used for clear coating may be any suitable paint, such as a two-component curing urethane paint, an aqueous emulsion paint or a UV-curable acrylic paint. A urethane paint is especially preferred.

In the practice of the invention, the structure, material and method of manufacture of the golf ball produced are not subject to any particular limitations. The ball may be molded from a known material by a conventional method. As for the ball structure, the ball may be a wound golf ball, a one-piece golf ball, a two-piece golf ball, or a multi-piece solid golf ball having a cover of two or more layers.

For example, in cases where the ball is a two-piece solid golf ball, production may be carried out by placing a prefabricated core in the cavity of an injection mold, then injection-molding a cover material over the core so as to encase the core with a cover having a plurality of dimples, thereby giving a two-piece solid golf ball. Also, after injection molding, a trimming operation is typically carried out to remove from the ball surface undesirable molded material (flash) that has formed from the cover resin. This grinding operation may be carried out by a known method.

As described above, the inventive method of manufacturing golf balls is an industrially advantageous process because it reliably removes cover grinding debris from the ball surface, enabling balls on which markings have been well-printed to be mass-produced, and also because it does not scratch the engraved plate used for pad printing, thus enabling the useful life of the plate to be extended.

### EXAMPLES

Examples of the invention and Comparative Examples are given below by way of illustration, and not by way of limitation.

### Examples 1 to 7, Comparative Examples 1 and 2

As shown in Table 1 below, golf balls with specific markings printed on the ball surface were fabricated by the golf ball manufacturing steps for Examples 1 to 7 and Comparative Examples 1 and 2. Pad printing was used to print all of the markings. In Comparative Example 2, unlike the other examples, pad printing was carried out after clear coating. Details on the ink used, the specific markings, pad printing, and heat and pressure treatment are given below.

### Ink

“A-93P PAD BLACK” ink available from Showa Ink Manufacturing Co., Ltd. was used.

### Logo

The logo mark “TOURSTAGE 10” having the design shown in FIG. 3 was printed onto the ball surface. The length of the logo “TOURSTAGE” was about 20 mm.

### Pad Printing

Navitas T-5F, manufactured by Navitas Co., Ltd., was used as the pad printing machine. A “Navitas A Type 2” pad made of silicone rubber was used as the stamping pad (for the pad printing machine).

### Heat and Pressure Treatment

As shown in FIG. 1, a hot pressing member 1 used in heat and pressure treatment has a metal plate 1a mounted thereon, and an elastomeric sheet 1b made of silicone rubber is attached to an outside surface of the metal plate 1a. The purpose of the elastomer sheet 1b is to absorb and even out the fine irregularities in the ball surface that have formed due to roughening in pretreatment.

Although not shown in the diagram, an electric heater is provided on the back side of the hot-pressing member 1. The heat generated by the electric heater passes from the metal plate 1a of the hot-pressing member 1 to the sheet 1b and, by having the sheet press up against the ball for a given length of time, is conducted to the ball surface. The fine irregularities on the ball surface that have formed due to roughening of the ball surface by pretreatment or the like can be evened out by such heat and pressure treatment.

In addition, although not shown in the diagram, a controller is provided for pressing the hot-pressing member 1 against the ball surface, which controller is coupled to an air cylinder and, by means of the air cylinder, can carry out the advance, pressing and retreat of the hot-pressing member 1 with respect to the ball surface.

The temperature, time and ball deformation in heat and pressure treatment for each of the examples are shown in Table 1. The pressure during pressing was set to 0.5 MPa.

### Steps

The golf ball production steps in each of Examples 1 to 7 and Comparative Examples 1 and 2 were as follows.

### (1) Examples 1 to 7

Core formation→Cover formation→Trimming of ball surface→Pretreatment (plasma or corona discharge treatment)→Heat and pressure treatment→Stamping (pad printing)→Clear coating

### (2) Comparative Example 1

Core formation→Cover formation→Trimming of ball surface→Pretreatment (plasma treatment)→Stamping (pad printing)→Clear coating

### (3) Comparative Example 2

Core formation→Cover formation→Trimming of ball surface→Pretreatment (plasma treatment)→Clear coating→Stamping (pad printing)

Unpainted two-piece balls having a core of crosslinked rubber composed primarily of polybutadiene rubber and, encasing the core, an approximately 2 mm thick layer of cover material composed primarily of ionomer resin and having a Shore D hardness of 65 were furnished as the golf balls to which markings are to be transferred.

The marked balls obtained by the production methods for the respective examples were evaluated as described below. The results are shown in Table 1.

### (1) Finished Appearance

The surface of the ball was visually rated according to the following criteria by production inspectors.
Exc: Markings are very clearly printed
Good: Markings are clearly printed
NG: Markings appear blurred and lack clean contours, or appear rough-edged.

### (2) Stamping Defect Rate

The frequency with which excess ink was printed outside of the markings on the ball surface was measured. In cases where cover grinding debris due to pretreatment remains on the ball surface following pretreatment of the golf ball, when ink is spread over the entire printing plate then ink outside of the recessed areas on the plate is removed, the grinding debris exerts an adverse influence, causing ink to remain behind in areas of the plate other than the recesses.

As a result, the stamping defect rate (%) tends to rise.

### (3) Plate Life

The number of impressions made up to the point where the plate had to be replaced was measured.

The cycle life of the plate is shortened on account of the adverse influence by cover grinding debris. In the operation of removing ink from areas other than the recesses after ink has been spread over the entire plate, the presence of residual grinding debris scratches the plate and ultimately forms other, unwanted, recesses on the plate in addition to the intended markings.

In the table, “1,000” signifies that there was no problem even when stamping was carried out 1,000 times.

### (4) Stamping Durability (COR Durability)

The durability of the golf ball was evaluated using an ADC Ball COR Durability Tester produced by Automated Design Corporation (U.S.). This tester functions so as to fire a golf ball pneumatically and cause it to repeatedly strike two metal plates arranged in parallel. The incident velocity against the metal plates was set at 43 m/s.
Good: No problem even after 100 or more shots.
NG: Some or all of the markings were stripped off after less than 100 shots

TABLE 1

| | | | Comparative | | | | | | |
|---|---|---|---|---|---|---|---|---|---|
| | Example | | Example | | | | | | |
| | 1 | 2 | 1 | 2 | 3 | 4 | 5 | 6 | 7 |
| Pretreatment | plasma | plasma/ | plasma | plasma | plasma | plasma | plasma | plasma | corona |
| | | clear | | | | | | | discharge |
| | | coating | | | | | | | |
| Heat and pressure | no | no | yes | yes | yes | yes | yes | yes | yes |
| treatment | | | | | | | | | |
| Ball deflection | 2 | 2 | 2 | 2 | 2 | 2 | 2 | 2 | 2 |
| during heat/pressure | | | | | | | | | |
| treatment (mm) | | | | | | | | | |
| Coating treatment | clear | no | clear | clear | clear | clear | clear | clear | clear |
| after stamping | coating | | coating | coating | coating | coating | coating | coating | coating |
| Heat/pressure | — | — | 100 | 100 | 130 | 150 | 150 | 200 | 200 |
| treatment | | | | | | | | | |
| temperature (° C.) | | | | | | | | | |
| Heat/pressure | — | — | 1.0 | 2.0 | 1.0 | 0.3 | 1.0 | 1.0 | 1.0 |
| treatment time (s) | | | | | | | | | |
| (1) Finished | NG | Exc | good | good | Exc | good | Exc | Exc | Exc |
| appearance | | | | | | | | | |
| (2) Stamping | 5 | 0 | 3 | 2 | 0 | 1 | 0 | 0 | 0 |
| defect rate | | | | | | | | | |
| (%) | | | | | | | | | |
| (3) Plate life | 205 | 1,000* | 304 | 412 | 1,000* | 526 | 1,000* | 1,000* | 1,000* |
| (impressions) | | | | | | | | | |
| (4) Stamping | good | NG | good | good | good | good | good | good | good |
| durability | | | | | | | | | |

1. A method of manufacturing golf balls, comprising the step of printing a specific marking on a surface of a golf ball by pad printing, wherein the printing step is preceded by the step of subjecting the ball surface to heat and pressure treatment.

2. The golf ball manufacturing method of claim 1, wherein the heat and pressure treatment is carried out by using a sheet heated in a given manner, said sheeting being pressed against the surface of the ball.

3. The golf ball manufacturing method of claim 2, wherein silicone rubber is used as the sheet.

4. The golf ball manufacturing method of claim 1 wherein, prior to carrying out heat and pressure treatment, the ball surface is pretreated by plasma treatment or corona discharge treatment.

5. The golf ball manufacturing method of claim 1, wherein the heat and pressure treatment conditions comprise heating in the range of 100° C. to 200° C.

6. The golf ball manufacturing method of claim 1, wherein, at the time of heat and pressure treatment, the ball has a deflection of from 0.2 mm to 5.0 mm.

7. The golf ball manufacturing method of claim 1, wherein pressure is applied during heat and pressure treatment for a period of from 0.1 second to 3.0 seconds.

8. A golf ball manufactured by the manufacturing method of claim 1.
